(19) United States
(12) Patent Application Publication
(10) Pub. No.: US 2016/0019900 A1
(43) Pub. Date: Jan. 21, 2016

(54) METHOD AND APPARATUS FOR LATTICE VECTOR QUANTIZATION OF AN AUDIO SIGNAL

(71) Applicant: NOKIA TECHNOLOGIES OY, Espoo (FI)

(72) Inventors: Adriana VASILACHE, Tampere (FI); Lasse Juhani LAAKSONEN, Tampere (FI); Anssi Sakari RÄMÖ, Tampere (FI)

(21) Appl. No.: 14/763,497

(22) PCT Filed: Feb. 1, 2013
(86) PCT No.: PCT/IB2013/050859

§ 371 Date: Jul. 24, 2015

(51) Int. Cl. G10L 19/008; G10L 19/038

(52) U.S. Cl. CPC G10L 19/008; G10L 19/038

(57) ABSTRACT

An apparatus comprising: a vector generator configured to generate a first vector of parameters defining at least one audio signal; a vector extender configured to extend the first vector of parameters to a second vector, where the first vector is length n and the second vector is length n, where m is greater than n; a vector transformer configured to transform the second vector, a lattice quantizer configured to lattice quantize the transformed second vector; and a reverse transformer configured to reverse transform the lattice quantized transformed second vector, such that the first n components of a reverse transformed lattice quantized transformed second vector are a lattice quantization of the first vector.

### FIELD

The present application relates to a multichannel or stereo audio signal encoder, and in particular, but not exclusively to a multichannel or stereo audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

Audio encoders and decoder are often designed as low complexity source coders. In other words able to perform encoding and decoding of audio signals without requiring highly complex processing.

An example of which is transform coding. For music signal audio encoding transform coding generally performs better than Algebraic Code Excited Linear Prediction (ACELP) technology which is better suited and directed for speech signals. Transform coding is performed by coding transform coefficients vector sub-band wise. In other words an audio signal is divided into sub-bands for which a parameter is determined and the parameters represent sub-vectors which are vector quantised.

### SUMMARY

There is provided according to a first aspect a method comprising: generating a first vector of parameters defining at least one audio signal; extending the first vector of parameters to a second vector, where the first vector is length n and the second vector is length m, where m is greater than n; transforming the 10 second vector; lattice quantizing the transformed second vector; and reverse transforming lattice quantized transformed second vector, such that the first n components of a reverse transformed lattice quantized transformed second vector are a lattice quantization of the first vector.

Generating a first vector of parameters defining at least one audio signal may comprise: dividing the at least one audio signal into time frames; transforming the time frames into frequency domain components; and dividing the frequency domain components into n sub-bands such that the first vector comprises the n sub-band frequency domain components.

Extending the first vector of parameters to a second vector, where the first vector is length n and the second vector is length m may comprise adding m-n null value component(s) to the first vector to extend the length of the first vector.

Transforming the second vector may comprise applying an inverse of a transformation matrix to the second vector, wherein the transformation matrix preserves the Euclidean norm.

The method as described herein wherein n may be a 7 dimension length vector, m may be a 8 dimension length vector x=(x₁ . . . x₈), and the transformation matrix may transform the condition from E₇={(x₁ . . . x₈)εE₈|x₁+ . . . +x₈=0} in having the last component zero or transform the condition E₇={(x₁ . . . x₈)εE₈|x₇=x₈} in having the last component zero, where E₇ is the n=7 dimension input vector lattice and the lattice E₈ is defined within Z₈ dimensional space by E₈={(x₁ . . . x₈)εZ₈|Σxᵢ≡0(mod 2)}∪{(x₁ . . . x₈)εZ₈+½|Σxᵢ≡0(mod 2)}.

The transformation matrix may be

$$( \begin{matrix}\sqrt{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{√ 6}{2} + 1 & \frac{√ 6}{6} + 1 & \frac{√ 6}{6} + 1 & \frac{√ 6}{6} + 1 & \frac{√ 6}{6} + 1 & \frac{√ 6}{6} + 1 & 1 \\ 1 & 1 & 2 \frac{√ 3}{3} + 1 & \frac{√ 3}{6} + 1 & \frac{√ 3}{6} + 1 & \frac{√ 3}{6} + 1 & \frac{√ 3}{6} + 1 & 1 \\ 1 & 1 & 1 & \frac{√ 5}{2} + 1 & \frac{√ 5}{10} + 1 & \frac{√ 5}{10} + 1 & \frac{√ 5}{10} + 1 & 1 \\ 1 & 1 & 1 & 1 & \frac{√ 30}{5} + 1 & \frac{√ 30}{30} + 1 & \frac{√ 30}{30} + 1 & 1 \\ 1 & 1 & 1 & 1 & 1 & \frac{√ 42}{36} + 1 & \frac{√ 42}{42} + 1 & 1 \\ 1 & 1 & 1 & 1 & 1 & 1 & 2 \frac{√ 14}{7} + 1 & 1 \\ 1 & 1 & 1 & 1 & 1 & 1 & 1 & 1\end{matrix} ) ,$$

wherein the transformation matrix transforms the condition from E₇={(x₁ . . . x₈)εE₈|x₁+ . . . +x₈=0} in having the last component zero.

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$

wherein the transformation matrix transforms the condition E₇={(x₁ . . . x₈)εE₈|x₇=x₈} in having the last component zero.

The method as described herein, wherein n may be a 6 dimension length vector, m may be a 8 dimension length vector, and the transformation matrix transforms the condition E₆={(x₁ . . . x₈)εE₈|x₆=x₇=x₈} in having the last two components zero or transforms the condition E₆={(x₁ . . . x₈)εE₈|x₁+x₈=x₂+ . . . +x₇=0} in having the last two components zero.

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$

wherein the first definition of the lattice E6 is satisfied E₆={(x₁ . . . x₈)εE₈|x₆=x₇=x₈}.

Lattice quantizing the transformed second vector may comprise: searching in D₈, wherein D₈ is defined as D₈={(x₁ . . . x₈)εZ₈|Σxᵢ≡0(mod 2)}; searching in D₈+0.5, wherein searching may comprise generating a lattice vector by rounding the input vector components to an integer according the definition and where the constraint on the sum modulo 2 is not respected the rounding on the input vector component with the highest rounding error is performed in the opposite direction; and selecting one of the lattice vectors from searched D₈ and D₈+0.5 lattices which is closest to the transformed second vector.

Reverse transforming the lattice quantized transformed second vector may comprise applying the transformation matrix to the selected one of the lattice vectors from searched D₈ and D₈+0.5 lattices which is closest to the transformed second vector.

According to a second aspect there is provided an apparatus comprising at least one processor and at least one memory including computer program code for one or more programs, the at least one memory and the computer program code configured to, with the at least one processor, cause the apparatus at least to: generate a first vector of parameters defining at least one audio signal; extend the first vector of parameters to a second vector, where the first vector is length n and the second vector is length m, where m is greater than n; transform the second vector, lattice quantize the transformed second vector; and reverse transform lattice quantized transformed second vector, such that the first n components of a reverse transformed lattice quantized transformed second vector are a lattice quantization of the first vector.

Generating a first vector of parameters defining at least one audio signal may cause the apparatus to: divide the at least one audio signal into time frames; transform the time frames into frequency domain components; and divide the frequency domain components into n sub-bands such that the first vector comprises the n sub-band frequency domain components.

Extending the first vector of parameters to a second vector, where the first vector is length n and the second vector is length m may cause the apparatus to add m-n null value component(s) to the first vector to extend the length of the first vector.

Transforming the second vector may cause the apparatus to apply an inverse of a transformation matrix to the second vector, wherein the transformation matrix preserves the Euclidean norm.

The apparatus as described herein wherein n may be a 7 dimension length vector, m may be a 8 dimension length vector x=(x₁ . . . x₈), and the transformation matrix may transform the condition from E₇={(x₁ . . . x₈)εE₈|x₁+ . . . +x₈=0} in having the last component zero or transform the condition E₇={(x₁ . . . x₈)εE₈|x₇=x₈} in having the last component zero, where E₇ may be the n=7 dimension input vector lattice and the lattice E₈ may be defined within Z₈ dimensional space by E₈={(x₁ . . . x₈)εZ₈|xᵢ≡0(mod 2)}∪{(x₁ . . . x₈)εZ₈+½|Σxᵢ≡0(mod 2)}.

The transformation matrix may be

$$( \begin{matrix}\sqrt{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{√ 6}{2} + 1 & \frac{√ 6}{6} + 1 & \frac{√ 6}{6} + 1 & \frac{√ 6}{6} + 1 & \frac{√ 6}{6} + 1 & \frac{√ 6}{6} + 1 & 1 \\ 1 & 1 & 2 \frac{√ 3}{3} + 1 & \frac{√ 3}{6} + 1 & \frac{√ 3}{6} + 1 & \frac{√ 3}{6} + 1 & \frac{√ 3}{6} + 1 & 1 \\ 1 & 1 & 1 & \frac{√ 5}{2} + 1 & \frac{√ 5}{10} + 1 & \frac{√ 5}{10} + 1 & \frac{√ 5}{10} + 1 & 1 \\ 1 & 1 & 1 & 1 & \frac{√ 30}{5} + 1 & \frac{√ 30}{30} + 1 & \frac{√ 30}{30} + 1 & 1 \\ 1 & 1 & 1 & 1 & 1 & \frac{√ 42}{36} + 1 & \frac{√ 42}{42} + 1 & 1 \\ 1 & 1 & 1 & 1 & 1 & 1 & 2 \frac{√ 14}{7} + 1 & 1 \\ 1 & 1 & 1 & 1 & 1 & 1 & 1 & 1\end{matrix} ) ,$$

where the transformation matrix may transform the condition from E₇={(x₁ . . . x₈)εE₈|x₁+ . . . +x₈=0} in having the last component zero.

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$

where the transformation matrix may transform the condition E₇={(x₁ . . . x₈)εE₈|x₇=x₈} in having the last component zero.

The apparatus as described herein, wherein n may be a 6 dimension length vector, m may be a 8 dimension length vector, and the transformation matrix may transform the condition E₆={(x₁ . . . x₈)εE₈|x₆=x₇=x₈} in having the last two components zero or transform the condition E₆={(x₁ . . . x₈)εE₈|x₁+x₈=x₂+ . . . +x₇=0} in having the last two components zero.

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$

where the first definition of the lattice E6 is satisfied E₆={(x₁ . . . x₈)εE₈|x₆=x₇=x₈}.

Lattice quantizing the transformed second vector may cause the apparatus to perform: searching in D₈, wherein D₈ may be defined as D₈={(x₁ . . . x₈)εZ₈|Σxᵢ≡0(mod 2)}; searching in D₈+0.5, wherein searching may cause the apparatus to generate a lattice vector by rounding the input vector components to an integer according the definition and where the constraint on the sum modulo 2 is not respected the rounding on the input vector component with the highest rounding error is performed in the opposite direction; and select one of the lattice vectors from searched D₈ and D₈+0.5 lattices which is closest to the transformed second vector.

Reverse transforming the lattice quantized transformed second vector may cause the apparatus to apply the transformation matrix to the selected one of the lattice vectors from searched D₈ and D₈+0.5 lattices which is closest to the transformed second vector.

According to a third aspect there is provided an apparatus comprising: means for generating a first vector of parameters defining at least one audio signal; means for extending the first vector of parameters to a second vector, where the first vector is length n and the second vector is length m, where m is greater than n; means for transforming the second vector, means for lattice quantizing the transformed second vector; and means for reverse transforming the lattice quantized transformed second vector, such that the first n components of a reverse transformed lattice quantized transformed second vector are a lattice quantization of the first vector.

The means for generating a first vector of parameters defining at least one audio signal may comprise: means for dividing the at least one audio signal into time frames; means for transforming the time frames into frequency domain components; and means for dividing the frequency domain components into n sub-bands such that the first vector comprises the n sub-band frequency domain components.

The means for extending the first vector of parameters to a second vector, where the first vector is length n and the second vector is length m may comprise means for adding m-n null value component(s) to the first vector to extend the length of the first vector.

The means for transforming the second vector may comprise means for applying an inverse of a transformation matrix to the second vector, wherein the transformation matrix preserves the Euclidean norm.

The apparatus as described herein, wherein n may be a 7 dimension length vector, m may be a 8 dimension length vector x=(x₁ . . . x₈), and the transformation matrix may transform the condition from E₇={(x₁ . . . x₈)εE₈|x₁+ . . . +x₈=0} in having the last component zero or transform the condition E₇={(x₁ . . . x₈)εE₈|x₇=x₈} in having the last component zero, where E₇ may be the n=7 dimension input vector lattice and the lattice E₈ may be defined within Z₈ dimensional space by E₈={(x₁ . . . x₈)εZ₈Σxᵢ≡0(mod 2)}∪{(x₁ . . . x₈)εZ₈+½|Σxᵢ≡0(mod 2)}.

The transformation matrix may be

$$( \begin{matrix}\begin{matrix}\sqrt{2} + \\ 1\end{matrix} & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{\sqrt{6}}{2} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & 1 \\ 1 & 1 & 2 \frac{\sqrt{3}}{3} + 1 & \frac{\sqrt{3}}{6} + 1 & \frac{\sqrt{3}}{6} + 1 & \frac{\sqrt{3}}{6} + 1 & \frac{\sqrt{3}}{6} + 1 & 1 \\ 1 & 1 & 1 & \frac{\sqrt{5}}{2} + 1 & \frac{\sqrt{5}}{10} + 1 & \frac{\sqrt{5}}{10} + 1 & \frac{\sqrt{5}}{10} + 1 & 1 \\ 1 & 1 & 1 & 1 & \frac{\sqrt{30}}{5} + 1 & \frac{\sqrt{30}}{30} + 1 & \frac{\sqrt{30}}{30} + 1 & 1 \\ 1 & 1 & 1 & 1 & 1 & \frac{\sqrt{42}}{36} + 1 & \frac{\sqrt{42}}{42} + 1 & 1 \\ 1 & 1 & 1 & 1 & 1 & 1 & 2 \frac{\sqrt{14}}{7} + 1 & 1 \\ 1 & 1 & 1 & 1 & 1 & 1 & 1 & 1\end{matrix} ) ,$$

where the transformation matrix may transform the condition from E₇={(x₁ . . . x₈)εE₈|x₁+ . . . +x=0} in having the last component zero.

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$

where the transformation matrix may transform the condition E₇={(x₁ . . . x₈)εE₈|x₇=x₈} in having the last component zero.

The apparatus as described herein, wherein n may be a 6 dimension length vector, m may be a 8 dimension length vector, and the transformation matrix may transform the condition E₆={(x₁ . . . x₈)εE₈|x₆=x₇=x₈} in having the last two components zero or transform the condition E₆={(x₁ . . . x₈)εE₈|x₁+x₈=x₂+ . . . +x₇=0} in having the last two components zero

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$

where the first definition of the lattice E6 is satisfied E₆={(x₁ . . . x₈)εE₈|x₆=x₇=x₈}.

Means for lattice quantizing the transformed second vector may comprise: means for searching in D₈, wherein D₈ may be defined as D₈={(x₁ . . . x₈)εZ₈|Σxᵢ≡0(mod 2)}; means for searching in D₈+0.5 by generating a lattice vector by rounding the input vector components to an integer according the definition and where the constraint on the sum modulo 2 is not respected the rounding on the input vector component with the highest rounding error is performed in the opposite direction; and means for selecting one of the lattice vectors from searched D₈ and D₈+0.5 lattices which is closest to the transformed second vector.

The means for reverse transforming the lattice quantized transformed second vector may comprise means for applying the transformation matrix to the selected one of the lattice vectors from searched D₈ and D₈+0.5 lattices which is closest to the transformed second vector.

According to a fourth aspect there is provided an apparatus comprising: a vector generator configured to generate a first vector of parameters defining at least one audio signal; a vector extender configured to extend the first vector of parameters to a second vector, where the first vector is length n and the second vector is length m, where m is greater than n; a vector transformer configured to transform the second vector a lattice quantizer configured to lattice quantize the transformed second vector and a reverse transformer configured to reverse transform the lattice quantized transformed second vector, such that the first n components of a reverse transformed lattice quantized transformed second vector are a lattice quantization of the first vector.

The vector generator may comprise: a framer configured to divide the at least one audio signal into time frames; a frequency transformer configured to transform the time frames into frequency domain components; and sub-band generator configured to divide the frequency domain components into n sub-bands such that the first vector comprises the n sub-band frequency domain components.

The vector extender may be configured to add m-n null value component(s) to the first vector to extend the length of the first vector.

The vector transformer may be configured to apply an inverse of a transformation matrix to the second vector, wherein the transformation matrix preserves the Euclidean norm.

The apparatus as described herein, wherein n may be a 7 dimension length vector, m may be a 8 dimension length vector x=(x₁ . . . x₈), and the transformation matrix may transform the condition from E₇={(x₁ . . . x₈)εE₈|x₁+ . . . +x₈=0} in having the last component zero or transform the condition E₇={(x₁ . . . x₈)εE₈|x₇=x₈} in having the last component zero, where E₇ may be the n=7 dimension input vector lattice and the lattice E₈ may be defined within Z₈ dimensional space by E₈={(x₁ . . . x₈)εZ₈|Σxᵢ≡0(mod 2)}∪{(x₁ . . . x₈)εZ₈+½|Σxᵢ≡0(mod 2)}.

The transformation matrix may be

$$( \begin{matrix}\begin{matrix}\sqrt{2} + \\ 1\end{matrix} & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{\sqrt{6}}{2} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & 1 \\ 1 & 1 & 2 \frac{\sqrt{3}}{3} + 1 & \frac{\sqrt{3}}{6} + 1 & \frac{\sqrt{3}}{6} + 1 & \frac{\sqrt{3}}{6} + 1 & \frac{\sqrt{3}}{6} + 1 & 1 \\ 1 & 1 & 1 & \frac{\sqrt{5}}{2} + 1 & \frac{\sqrt{5}}{10} + 1 & \frac{\sqrt{5}}{10} + 1 & \frac{\sqrt{5}}{10} + 1 & 1 \\ 1 & 1 & 1 & 1 & \frac{\sqrt{30}}{5} + 1 & \frac{\sqrt{30}}{30} + 1 & \frac{\sqrt{30}}{30} + 1 & 1 \\ 1 & 1 & 1 & 1 & 1 & \frac{\sqrt{42}}{36} + 1 & \frac{\sqrt{42}}{42} + 1 & 1 \\ 1 & 1 & 1 & 1 & 1 & 1 & 2 \frac{\sqrt{14}}{7} + 1 & 1 \\ 1 & 1 & 1 & 1 & 1 & 1 & 1 & 1\end{matrix} ) ,$$

where the transformation matrix may transform the condition from E₇={(x₁ . . . x₈)εE₈|x₁+ . . . +x₈=0} in having the last component zero. The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$

where the transformation matrix may transform the condition E₇={(x₁ . . . x₈)εE₈|x₇=x₈} in having the last component zero.

The apparatus as described herein, wherein n may be a 6 dimension length vector, m may be a 8 dimension length vector, and the transformation matrix may transform the condition E₆={(x₁ . . . x₈)εE₈|x₆=x₇=x₈} in having the last two components zero or transform the condition E₆={(x₁ . . . x₈)εE₈|x₁+x₈=x₂+ . . . +x₇=0} in having the last two components zero

The transformation matrix may be

$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$

where the first definition of the lattice E6 is satisfied E₆={(x₁ . . . x₈)εE₈|x₆=x₇=x₈}.

The lattice quantizer may comprise: a searcher configured to search in D₈, wherein D₈ may be defined as D₈={(x₁ . . . x₈)εZ₈|Σxᵢ≡0(mod 2)}; the searcher may be further configured to search in D₈+0.5, wherein the searcher may be configured to generate a lattice vector by rounding the input vector components to an integer according the definition and where the constraint on the sum modulo 2 is not respected the rounding on the input vector component with the highest rounding error is performed in the opposite direction; and a selector configured to select one of the lattice vectors from searched D₈ and D₈+0.5 lattices which is closest to the transformed second vector.

The reverse transformer may be configured to apply the transformation matrix to the selected one of the lattice vectors from searched D₈ and D₈+0.5 lattices which is closest to the transformed second vector.

A computer program product may cause an apparatus to perform the method as described herein.

An electronic device may comprise apparatus as described herein.

A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing some embodiments;

FIG. 2 shows schematically an audio codec system according to some embodiments;

FIG. 3 shows schematically an encoder as shown in FIG. 2 according to some embodiments;

FIG. 4 shows schematically a parameter encoder as shown in FIG. 3 in further detail according to some embodiments;

FIG. 5 shows a flow diagram illustrating the operation of the encoder shown in FIG. 3 according to some embodiments;

FIG. 6 shows a flow diagram illustrating the operation of the parameter encoder as shown in FIG. 5 in further detail according to some embodiments;

FIG. 7 shows a flow diagram illustrating the operation of the vector converter as shown in FIG. 5 in further detail according to some embodiments;

FIG. 8 shows a flow diagram illustrating a further operation of the vector converter as shown in FIG. 5 in further detail according to some embodiments; and

FIG. 9 shows a graph of RD function for Z₇ and E₇ for Gaussian data in example implementations of some embodiments.

### DESCRIPTION OF SOME EMBODIMENTS OF THE APPLICATION

The following describes in more detail possible stereo and multichannel speech and audio codecs, including layered or scalable variable rate speech and audio codecs.

There can be a problem with current transform coding approaches in that the use of compression efficient lattices can improve significantly the quantisation however the best lattices in six and seven dimensions do not have fast nearest neighbour algorithms.

In some situations the number of sub-bands used can be modified to a number suitable for producing a vector able to use a fast nearest neighbour algorithm, for example Z₈. In other words the codec generates eight sub-bands from which it is possible to use of the lattice E₈ for which fast nearest neighbour algorithms exist. However by modifying the sub band length to 8, for example the lower frequency sub bands, the modification interferes with the typical purpose of using the sub-bands corresponding to psychoacoustically relevant sub bands or psychoacoustically relevant sub-band division.

The concept for these embodiments as described herein is to attempt to propose nearest neighbour algorithms for the lattices E₆ and E₇. These nearest neighbour algorithms are fast algorithms but they also operate as search algorithms for these lattices.

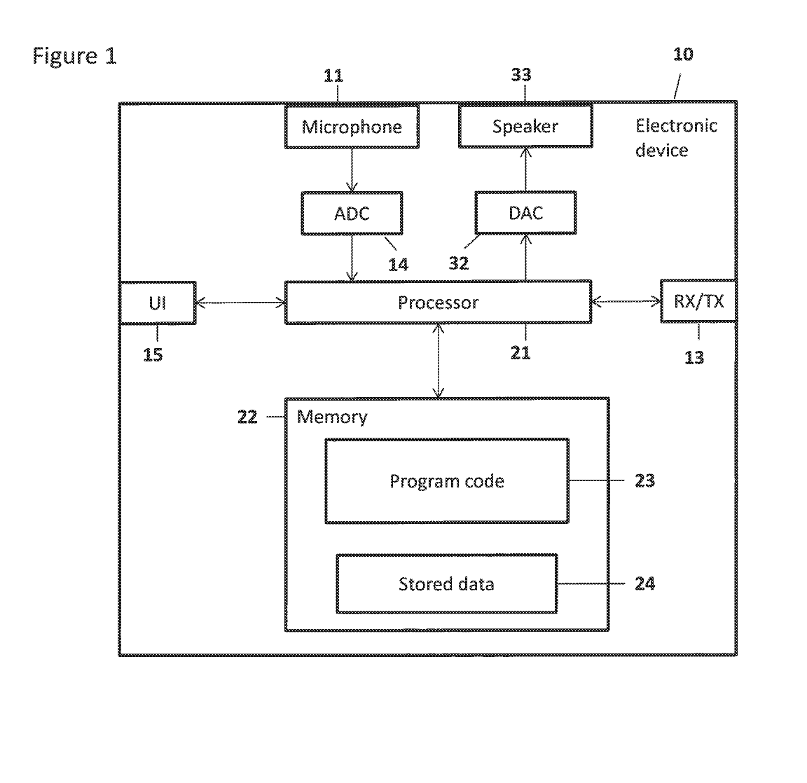

In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The Implemented program codes in some embodiments comprise an audio encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented at least partially in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

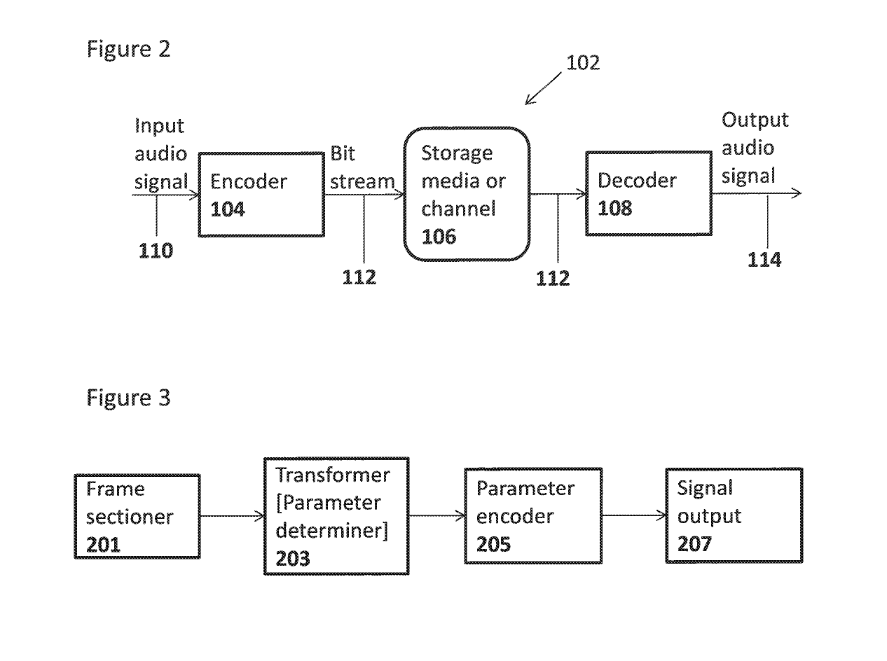

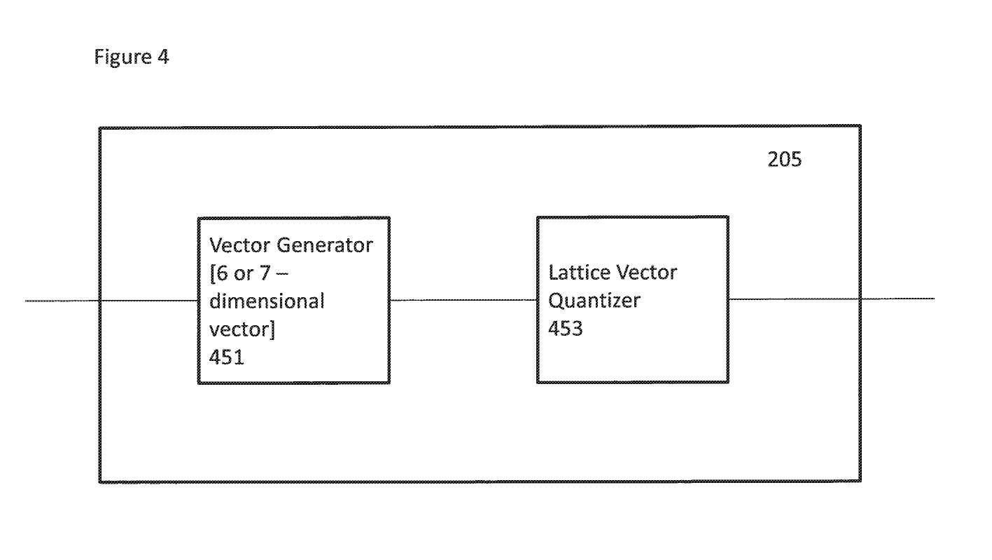

The processor 21 in such embodiments then processes the digital audio signal in the same way as described with reference to the system shown in FIG. 2, and specifically the encoder shown in FIGS. 3 to 9.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

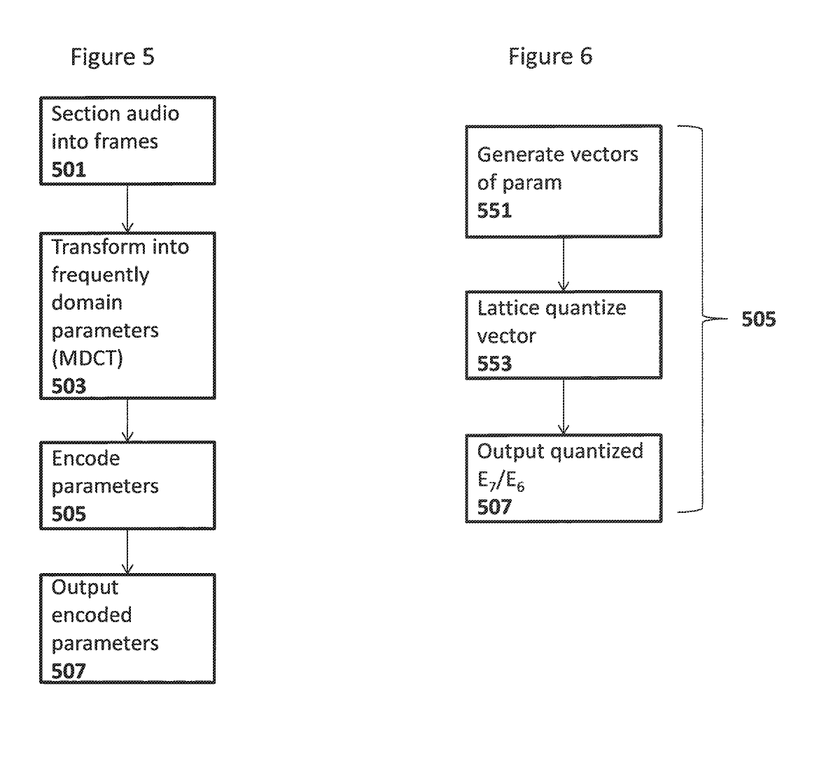

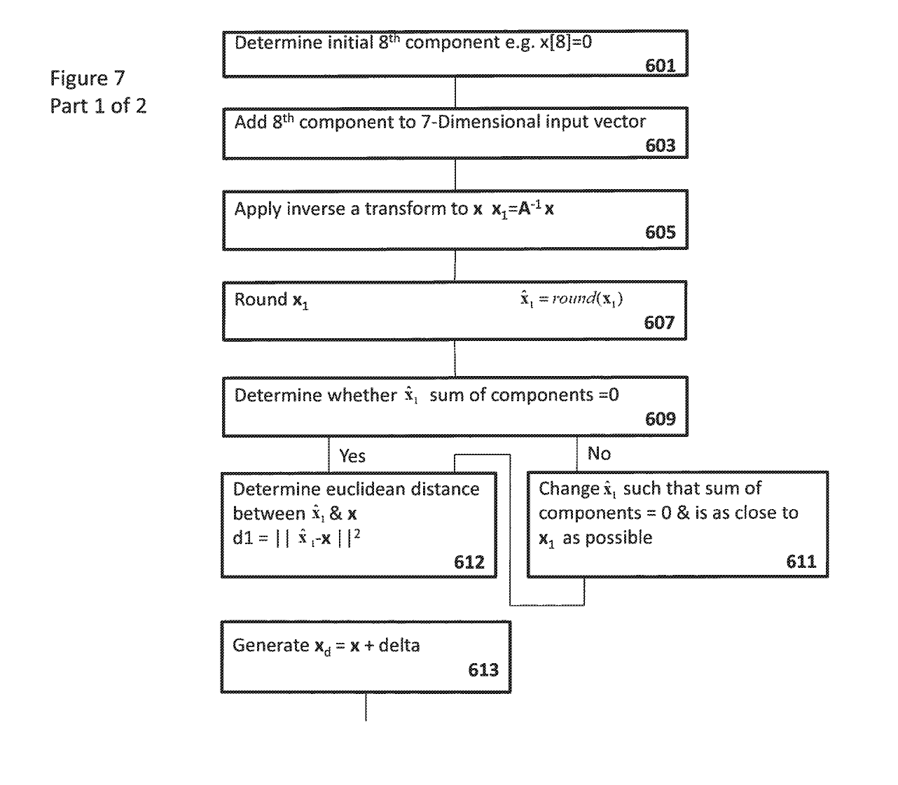

It would be appreciated that the schematic structures described in FIGS. 3 and 4, and the method steps shown in FIGS. 5 to 8 represent only a part of the operation of an audio codec and specifically part of an audio encoder apparatus or method as exemplarily shown implemented in the apparatus shown in FIG. 1.

The general operation of audio codecs as employed by embodiments is shown in FIG. 2. General audio coding/decoding systems comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104, a storage or media channel 106 and a decoder 108. It would be understood that as described above some embodiments can comprise or implement one of the encoder 104 or both the encoder 104 and decoder 108.

The encoder 104 compresses an input audio signal 110 producing a bit stream 112, which in some embodiments can be stored or transmitted through a media channel 106. The encoder 104 can in some embodiments comprise a multi-channel encoder that encodes two or more audio signals.

The bit stream 112 can be received within the decoder 108. The decoder 108 decompresses the bit stream 112 and produces an output audio signal 114. The decoder 108 can comprise a transform decoder as part of the overall decoding operation. The decoder 108 can also comprise a multi-channel decoder that decodes two or more audio signals. The bit rate of the bit stream 112 and the quality of the output audio signal 114 in relation to the input signal 110 are the main features which define the performance of the coding system 102.

FIG. 3 shows schematically the encoder 104 according to some embodiments.

FIG. 5 shows schematically in a flow diagram the operation of the encoder 104 according to some embodiments.

The concept for the embodiments as described herein is to determine and apply encoding to audio signals to produce efficient high quality and low bit rate real life coding. To that respect with respect to FIG. 3 an example encoder 104 is shown according to some embodiments. Furthermore with respect to FIG. 5 the operation of the encoder 104 is shown in further detail. In the following examples the encoder is configured to generate frequency domain parameters representing the audio signal and encode the generated frequency domain parameters using a suitable vector lattice quantization, however it would be understood that in some embodiments the parameters used in the lattice quantization as described herein can be any suitable parameters defining or representing the audio signals or other type of signals (for example image or, video).

The encoder 104 in some embodiments comprises a frame sectioner 201 or suitable means for sectioning the audio signal. The frame sectioner 201 is configured to receive the audio signals (for example a mono, left and right stereo or any multichannel audio representation) input audio signal and section or segment the audio signal data into sections or frames suitable for frequency or other domain transformation. The frame sectioner 201 in some embodiments can further be configured to window these frames or sections of audio signal data according to any suitable windowing function. For example the frame sectioner 201 can be configured in some embodiments to generate frames of 20 ms which overlap preceding and succeeding frames by 10 ms each.

The operation of generating audio frames is shown in FIG. 5 by step 501.

In some embodiments the audio frames can be passed to a transformer 203.

In some embodiments the encoder comprises a transformer 203 or suitable means for transforming. The transformer 203 in some embodiments is configured to generate frequency domain (or other suitable domain) representations of these audio signals to be analysed and encoded. These frequency domain representations can be passed to the parameter encoder 205.

In some embodiments the transformer 203 can be configured to perform any suitable time to frequency domain transformation on the audio signal data. For example the time to frequency domain transformation can be a discrete Fourier transform (DFT), Fast Fourier transform (FFT), modified discrete cosine transform (MDCT). In the following examples a Fast Fourier Transform (FFT) is used.

Furthermore the transformer can further be configured to generate separate frequency band domain representations (sub-band representations or sub-band parameter representations) of each input channel audio signal data. These bands can be arranged in any suitable manner. For example these bands can be linearly spaced, or be perceptual or psychoacoustically allocated.

The operation of generating audio frame band frequency domain representations or transforming the sectioned frames into frequency domain parameters is shown in FIG. 5 by step 503.

In some embodiments the frequency domain representations are passed to a parameter encoder 205.

In some embodiments the encoder 104 can comprise a parameter encoder 205. The parameter encoder 205 can be configured to receive the sub-band parameter representations of the audio signal input. The parameter encoder 205 can furthermore in some embodiments be configured to use each of the sub-band values as a sub-vector and combine each sub-vector to create a vector to input into a vector quantizer. In other words the apparatus can comprise a vector generator configured to generate a first vector of parameters defining at least one audio signal.

The output of the vector quantizer is in some embodiments the encoder and therefore the vector quantized audio signals output are the ‘encoded’ or parameter encoded representations of the audio signal.

The operation of encoding or vector quantizing the parameters is shown in FIG. 5 by step 505

The encoded signal can be output.

The operation of outputting the encoded signal is shown in FIG. 5 by step 507.

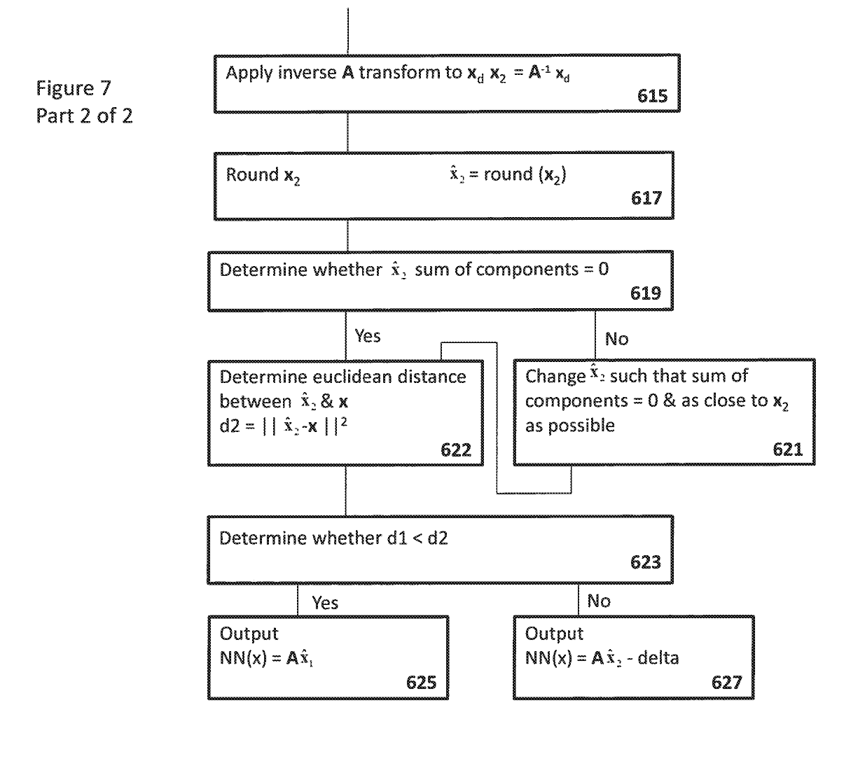

With respect to FIG. 4 an example parameter encoder 205 according to some embodiments is described in further detail. Furthermore with respect to FIG. 6 the operation of the parameter encoder 205 as shown in FIG. 4 is shown according to some embodiments.

In some embodiments the parameter encoder 205 comprises a vector generator 451. The vector generator 451 is configured to receive the sub-band transform parameters and generate a 6 or 7 dimensional vector from these values.

The operation of generating vectors from the input parameters is shown in FIG. 6 by step 551.

The generated vectors can in some embodiments be passed to the lattice vector quantizer 453.

In some embodiments the parameter encoder 205 comprises a lattice vector quantizer 453. The lattice vector quantizer 453 receives the input vector generated from the transform parameters and generates a nearest neighbour or NN output which occurs within a defined lattice and thus can be decoded using a similar lattice at the decoder.

In order to understand the advantages of the embodiments described herein an indication of the quantization performance of the lattice is determined by a second order normalized moment, G, of the lattice indicates.

For example the values of G for lattice dimensions 6 and 7 are shown in the following table:

| Lattice quantizer | G | Lower bound |
|---|---|---|
| E6 | 0.074347 | 0.07347 |
| E6* | 0.074244 | 0.07347 |
| E7 | 0.073231 | 0.07248 |
| E7* | 0.073116 | 0.07248 |

Comparing with the normalized second order moment for Z₆ or Z₇ which is 0.08333, there is a clear improvement in using these lattices as compared to using the full space and performing spatial vector quantization.

The lattice E₇ can be defined for instance as:

E₇={(x₁ . . . x₈)εE₈|x₁+ . . . +x₈=0}

or

E₇={(x₁ . . . x₈)εE₈|x₇=x₈}

where the lattice E₈ is defined as

E₈={(x₁ . . . x₈)εZ₈|Σxᵢ≡0(mod 2)}∪{(x₁ . . . x₈)εZ₈+½|Σxᵢ≡0(mod 2)}

The search in E₈ can be made by first searching in D₈ and then in D₈+½. The search in D8 is done by rounding to an integer according to the definition and if the constraint on the sum modulo 2 is not respected, the rounding on the component with highest rounding error is done in the opposite direction (e.g. if 2.48 was rounded down to 2, it will be rounded up to 3). D₈ is defined as:

D₈={(x₁ . . . x₈)εZ₈|Σxᵢ≡0(mod 2)}

The concept in some embodiments is determining or presenting a nearest neighbour search algorithm for example E₇ given a 7-dimensional input vector (or similarly in some embodiments E₆ given a 6-dimensional input vector) where an eighth (or seventh and eighth) component is added such that after a search in E₈ using a transformed version of the extended vector the condition from the either

E₇={(x₁ . . . x₈)εE₈|x₁+ . . . +x₈=0}

or

E₇={(x₁ . . . x₈)εE₈|x₇=x₈}

is fulfilled and the resulting E₈ vector is transformed back such that its Euclidean norm is preserved and the last component is zero.

The operation of Lattice quantizing the vector is shown in FIG. 6 by step 553.

Furthermore the operation of outputting the quantized vector is shown in FIGS. 5 and 6 by step 507.

It would be understood that when the E8 vector is transformed back and a vector is obtained such that it has the last component 0, which is ignored, the output vector is not a E8 vector but a E6/E7 vector.

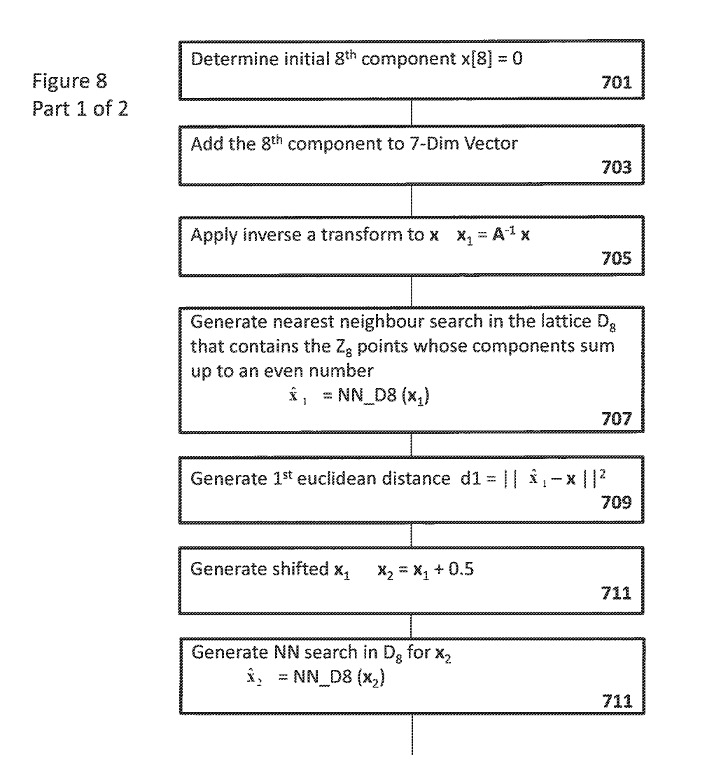

With respect to FIG. 7 a flow diagram showing a first example operation of the lattice vector quantizer according to some embodiments is shown. In this example the input vector is a 7-dimensional input vector.

The lattice vector quantizer 453 can in some embodiments first determine an initial 8^{th} component for the vector. The initial 8^{th} component can in some embodiments be zero or in other words x[8]=0. In other words in some embodiments the lattice vector quantizer comprises a vector extender or means for extending the input vector configured to extend the first vector of parameters to a second vector, where the first vector is length n and the second vector is length m, where m is greater than n.

The operation of determining the initial 8^{th} component is shown in FIG. 7 by step 601.

The lattice vector quantizer 453 can in some embodiments then add the eighth component x[8] to the 7-dimension input vector x[0 . . . 7].

The operation of adding the 8^{th} component to the 7-dimensional input vector is shown in FIG. 7 by step 603.

The lattice vector quantizer 453 can in some embodiments can comprise a vector transformer or means for transforming configured to transform the second vector. In some embodiments the transformer is configured to apply an inverse of a defined transformation matrix A. The transformation matrix A preserves the Euclidean norm and transforms the condition from E₇={(x₁ . . . x₈)εE₈|x₁+ . . . +x₈=0} in having the last component zero or preserves the Euclidean norm and transforms the condition E₇={(x₁ . . . x₈)εE₈|x₇=x₈} in having the last component zero.

$$A = ( \begin{matrix}\sqrt{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{\sqrt{6}}{2} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & 1 \\ 1 & 1 & 2 \frac{\sqrt{3}}{3} + 1 & \frac{\sqrt{3}}{6} + 1 & \frac{\sqrt{3}}{6} + 1 & \frac{\sqrt{3}}{6} + 1 & \frac{\sqrt{3}}{6} + 1 & 1 \\ 1 & 1 & 1 & \frac{\sqrt{5}}{2} + 1 & \frac{\sqrt{5}}{10} + 1 & \frac{\sqrt{5}}{10} + 1 & \frac{\sqrt{5}}{10} + 1 & 1 \\ 1 & 1 & 1 & 1 & \frac{\sqrt{30}}{5} + 1 & \frac{\sqrt{30}}{30} + 1 & \frac{\sqrt{30}}{30} + 1 & 1 \\ 1 & 1 & 1 & 1 & 1 & \frac{\sqrt{42}}{36} + 1 & \frac{\sqrt{42}}{42} + 1 & 1 \\ 1 & 1 & 1 & 1 & 1 & 1 & 2 \frac{\sqrt{14}}{7} + 1 & 1 \\ 1 & 1 & 1 & 1 & 1 & 1 & 1 & 1\end{matrix} )$$

For example a suitable matrix A which obeys the two constrains is

The application of the inverted transformation matrix to the extended vector generates a first transformed vector x1 (or x₁)

x₁=A⁻¹x

The operation of applying the inverse of the transformation matrix to the extended vector is shown in FIG. 7 by step 605.

The lattice vector quantizer 453 can in some embodiments be configured to lattice quantize the transformed ‘second’ or extended vector.

For example in some embodiments the lattice vector quantizer 453 can be configured to further round the first transformed vector x1.

\hat{x}₁=round(x₁)

The operation of rounding the first transformed vector is shown in FIG. 7 by step 607.

The lattice vector quantizer 453 can in some embodiments further determine whether the sum of the components of \hat{x}₁=0.

The operation of determining where the sum of components is equal to zero is shown in FIG. 7 by step 609.

Where the sum of components does not equal 0 then in some embodiments the lattice vector quantizer 453 can be configured to change \hat{x}₁ such that the sum of components is equal to zero and is as close as can be to x₁. In some embodiments this can be achieved for example by the following operations

```
  dif = x1−x1_hat;
  s = round((sum(dif)));
  if (s<0)
    dif(dif>0) = 0;
    [sortd, idx] = sort(dif);
    x1_hat(idx(1:−s)) = x1_hat(idx(1:−s))+sign(dif(idx(1:−s)));
  else
    dif(dif<0) = 0;
    [sortd, idx] = sort(dif);
    x1_hat(idx(end−s+1:end))=x1_hat(idx(end−
s+1:end))+sign(dif(idx(end−s+1:end)));
  end
where x₁=x1, and \hat{x}₁ =x1_hat.
```

The operation can then pass to the Euclidean distance determination.

The operation of changing \hat{x}₁ such that the sum of components is equal to zero and is as close as can be to x₁ is shown in FIG. 7 by step 611.

The lattice vector quantizer 453 can in some embodiments further determine a first Euclidean distance between \hat{x}₁ and x.

d1=∥\hat{x}₁−x∥²

The operation of determining the first Euclidean distance is shown in FIG. 7 by step 612.

The lattice vector quantizer 453 can in some embodiments further determine a shifted extended vector

x_{d}=x+delta

where delta=A*[0.5 0.5 0.5 0.5 0.5 0.5 0.5 0.5]′

The operation of generating the shifted extended vector is shown in FIG. 7 by step 613.

The lattice vector quantizer 453 can in some embodiments apply an inverse of a defined transformation matrix A to the shifted extended vector. The transformation matrix A as determined herein preserves the Euclidean norm and transforms the condition from E₇={(x₁ . . . x₈)εE₈|x₁+ . . . +x₈=0} in having the last component zero or preserves the Euclidean norm and transforms the condition E₇={(x₁ . . . x₈)εE₈|x₇=x₈} in having the last component zero.

The application of the inverted transformation matrix to the shifted vector generates a second transformed vector x2 (or x₂)

x₂=A⁻¹x_{d}

The operation of applying the inverse of the transformation matrix to the shifted extended vector is shown in FIG. 7 by step 615.

The lattice vector quantizer 453 can in some embodiments further round the second transformed vector x2.

\hat{x}₂=round(x₂)

The operation of rounding the second transformed vector is shown in FIG. 7 by step 617.

The lattice vector quantizer 453 can in some embodiments further determine whether the sum of the components of \hat{x}₂=0.

The operation of determining where the sum of components is equal to zero is shown in FIG. 7 by step 619.

Where the sum of components does not equal 0 then in some embodiments the lattice vector quantizer 453 can be configured to change \hat{x}₂ such that the sum of components is equal to zero and is as close as can be to x₂. In some embodiments this can be achieved by the code described herein and by replacing x2 for x1 and x2_hat for x1_hat.

The operation can then pass to the Euclidean distance determination.

The operation of changing \hat{x}₂ such that the sum of components is equal to zero and is as close as can be to x₂ is shown in FIG. 7 by step 621.

The lattice vector quantizer 453 can in some embodiments further determine a first Euclidean distance between \hat{x}₂ and x.

d2=∥\hat{x}₂−x∥²

The operation of determining the second Euclidean distance is shown in FIG. 7 by step 622.

The lattice vector quantizer 453 can in some embodiments determine whether the first distance d1 is equal to or less than the second distance d2.

The operation of determining whether the first distance is equal to or less than the second distance is shown in FIG. 7 by step 623.

Where the first distance is equal to or less than the second distance the lattice vector quantizer 453 can be configured to output the nearest neighbour vector which is A applied to \hat{x}₁.

In other words NN(x)=Δ\hat{x}₁,

The operation of outputting the first rounded vector derived lattice value is shown in FIG. 7 by step 625.

Where the first distance is greater than the second distance the lattice vector quantizer 453 can be configured to output the nearest neighbour vector which is A applied to \hat{x}₂ with the vector delta subtracted.

In other words NN(x)=A\hat{x}₂−delta

The operation of outputting the second rounded vector derived lattice value is shown in FIG. 7 by step 627.

The output of the embodiment described herein is the first seven components of NN(x) (the last one being zero) which is the nearest neighbour of x in the lattice E₇.

In some embodiments therefore the lattice quantizer can comprise a reverse transformer configured to reverse transform the lattice quantized transformed 10 second vector or means for applying the transformation matrix. The output of which is such that the first n components of a reverse transformed lattice quantized transformed ‘second’ or extended vector are a lattice quantization of the ‘first’ or original parameter vector.

These operations can in other words be expressed by the following pseudocode.

| | |
|---|---|
| 1. | Add the 8^{th} component to x, x[8] = 0 |
| 2. | Apply the inverse transform x₁ = A⁻¹x |
| 3. | x1_hat = round(x₁) |
| 4. | If Σᵢ₌₁⁸ \hat{x}₁ [i] = 0 |

| | |
|---|---|
| a. | d1 = \|\|\hat{x}₁ − x\|\|² |

Else

| | |
|---|---|
| a. | Change x1_hat such that the sum of its components |
| | is zero and it is as close as possible to x1 |
| b. | d1 = \|\|\hat{x}₁ − x\|\|² |

| | |
|---|---|
| | End |
| 5. | x₂ = x+delta |
| 6. | x₂=A−¹x₂ |
| 7. | x2_hat = round(x₂) |
| 8. | If Σᵢ₌₁⁸ \hat{x}₂ [i] = 0 |

| | |
|---|---|
| a. | d2 = \|\|\hat{x}₂ − x\|\|² |

Else

| | |
|---|---|
| c. | Change x2_hat such that the sum of its components |
| | is zero and it is as close as possible to x2 |
| d. | d2 = \|\|\hat{x}₂ − x\|\|² |

| | |
|---|---|
| | End |
| 9. | If d1<= d2 |
| | NN(x) = A x1_hat |
| | Else |
| | NN(x) = A x2_hat−delta |
| | End |

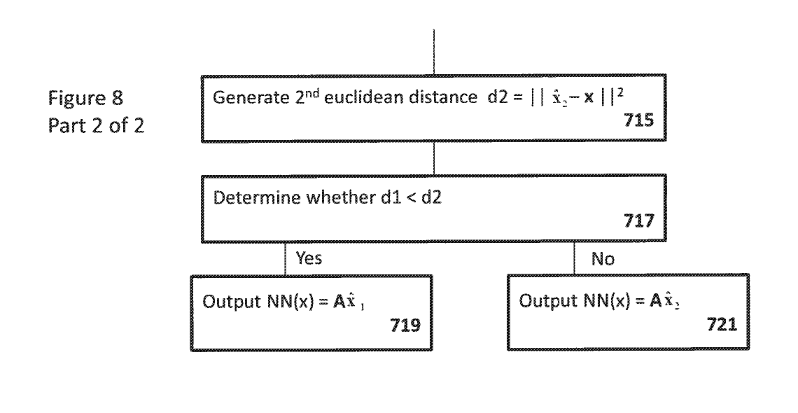

With respect to FIG. 8 a flow diagram showing a second example operation of the lattice vector quantizer according to some embodiments is shown. In this example the input vector is a 7-dimensional input vector.

The lattice vector quantizer 453 can in some embodiments first determine an initial 8^{th} component for the vector. The initial 8^{th} component can in some embodiments be zero or in other words x[8]=0.

The operation of determining the initial 8^{th} component is shown in FIG. 8 by step 601.

The lattice vector quantizer 453 can in some embodiments then add the eighth component x[8] to the 7-dimension input vector x[0 . . . 7].

The operation of adding the 8 component to the 7-dimensional input vector is shown in FIG. 8 by step 703.

The lattice vector quantizer 453 can in some embodiments apply an inverse of a defined transformation matrix A. The transformation matrix A preserves the Euclidean norm and transforms the condition E₇={(x₁ . . . x₈)εE₈|x₇=x₈} into having the last component zero.

For example a suitable matrix A which obeys the constrains is

$$A = ( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} )$$

The application of the inverted transformation matrix to the extended vector generates a first transformed vector x1 (or x₁)

x₁=A⁻¹x

The operation of applying the inverse of the transformation matrix to the extended vector is shown in FIG. 8 by step 607.

The lattice vector quantizer 453 can in some embodiments apply a nearest neighbour search in the lattice D₈ whose components sum up to an even number to generate a first estimate vector \hat{x}₁. In other words performing a nearest neighbour search for the following lattice D₈={(x₁ . . . x₈)εZ₈|Σxᵢ≡0(mod 2)}.

The operation of applying a nearest neighbour search in the lattice D₈ is shown in FIG. 8 by step 707.

The lattice vector quantizer 453 can in some embodiments further determine a first Euclidean distance between \hat{x}₁ and x.

d1=∥\hat{x}₁−x∥²

The operation of determining the first Euclidean distance is shown in FIG. 8 by step 709.

The lattice vector quantizer 453 can in some embodiments further determine a shifted vector x₂ from x₁, using the expression x₂=x₁−0.5.

The generation of the second extended vector is shown in FIG. 8 by step 711.

The lattice vector quantizer 453 can in some embodiments apply a nearest neighbour search to the second extended vector in the lattice D₈ whose components sum up to an even number to generate a second estimate vector \hat{x}₂. In other words performing a nearest neighbour search for the following lattice D₈={(x₁ . . . x₈)εZ₈|Σxᵢ≡0(mod 2)}.

It would be understood that in order to compensate for the 0.5 shift, \hat{x}₂=\hat{x}₂+0.5.

The operation of applying a nearest neighbour search to x₂ in the lattice D₈ is shown in FIG. 8 by step 713.

The lattice vector quantizer 453 can in some embodiments further determine a first Euclidean distance between \hat{x}₂ and x.

d2=∥\hat{x}₂−x∥²

The operation of determining the second Euclidean distance is shown in FIG. 8 by step 715.

The lattice vector quantizer 453 can in some embodiments determine whether the first distance d1 is equal to or less than the second distance d2.

The operation of determining whether the first distance is equal to or less than the second distance is shown in FIG. 8 by step 717.

Where the first distance is equal to or less than the second distance the lattice vector quantizer 453 can be configured to output the nearest neighbour vector which is A applied to \hat{x}₁.

In other words

NN(x)=A\hat{x}₁

The operation of outputting the first rounded vector derived lattice value is shown in FIG. 8 by step 719.

Where the first distance is greater than the second distance the lattice vector quantizer 453 can be configured to output the nearest neighbour vector which is A applied to \hat{x}₂.

In other words

NN(x)=A\hat{x}₂

The operation of outputting the second rounded vector derived lattice value is shown in FIG. 8 by step 721.

These operations can in other words be expressed by the following pseudocode.

| | |
|---|---|
| 1. | Add the 8^{th} component to x, x[8] = 0 |
| 2. | Apply the inverse transform x₁ =A⁻¹x |
| 3. | x1_hat = NN_D8(x₁) |
| 4. | d1 = \|\|\hat{x}₁ − x\|\|² |
| 5. | x₂ = x₁ − 0.5; |
| 6. | x2_hat = NN_D8(x₂)+0.5; |
| 7. | If d1<=d2 |
| | NN(x) = A x1_hat |
| | Else |
| | NN(x) = A x2_hat |
| | End |

In the operations described herein the E₇ matrix has been used. In some embodiments the input vector can be a 6-dimensional vector. In such embodiments the definitions for the lattice E₆ are:

E₆={(x₁ . . . x₈)εE₈|x₁+x₈=x₂+ . . . +x₇=0}

or

E₆={(x₁ . . . x₈)εE₈|x₆=x₇=x₈}

In such embodiments the lattice vector quantizer can be configured to apply the operations described above but by determining both the seventh and eighth components as zero. In other words x[7]=0 and x[8]=0.

Furthermore the matrix A for the 6-dimensional input is given by

$$A = ( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} )$$

where the second definition of the lattice E6 is satisfied E₆={(x₁ . . . x₈)εE₈|x₆=x₇=x₈}.

In other words for lattice E6 it is possible to apply the latter algorithm (satisfying the condition on the equality in the last components).

In some embodiments the nearest neighbour in E₆ is given by the first 6 components of algorithm's output, NN(x).

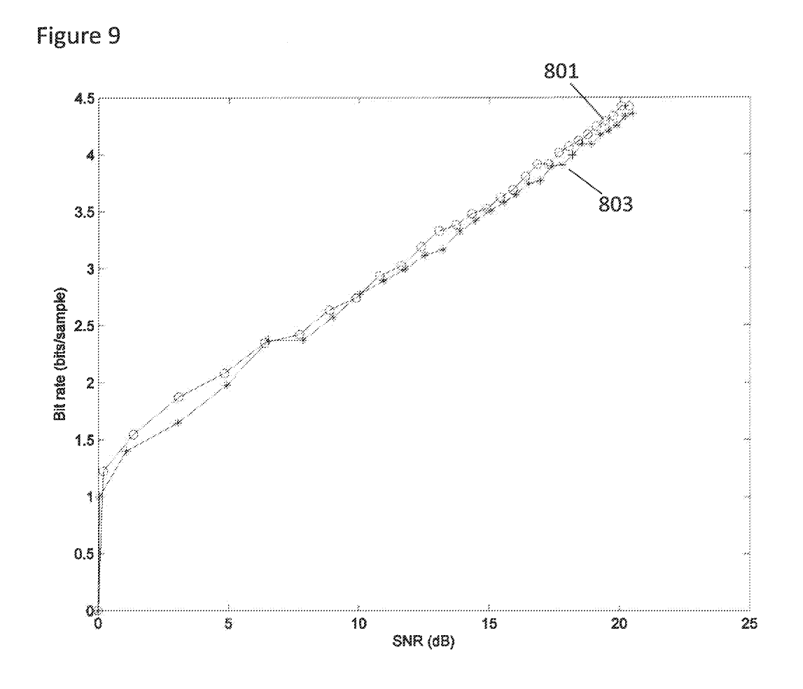

With respect to FIG. 9 an example of the rate-distortion function for E₇ 803 compared with Z₇ 801 currently used is shown. It can be seen that both algorithms give similar rate-distortion functions. The performance of the E₇ lattice however is better than for Z₇ for all considered bitrates. In the example shown the data used was Gaussian, and the lattices were spherically truncated to conform to the shape of the input distribution.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or Interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of Integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules.

Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as Implementations in only analogue and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-23. (canceled)

24. A method comprising:
generating a first vector of parameters defining at least one audio signal; extending the first vector of parameters to a second vector, where the first vector is length n and the second vector is length m, where m is greater than n;
transforming the second vector;
lattice quantizing the transformed second vector; and
reverse transforming lattice quantized transformed second vector, such that the first n components of a reverse transformed lattice quantized transformed second vector are a lattice quantization of the first vector.

25. The method as claimed in claim 24, wherein generating a first vector of parameters defining at least one audio signal comprises:
dividing the at least one audio signal into time frames;
transforming the time frames into frequency domain components; and
dividing the frequency domain components into n sub-bands such that the first vector comprises the n sub-band frequency domain components.

26. The method as claimed in claim 24, wherein extending the first vector of parameters to a second vector, where the first vector is length n and the second vector is length m comprises adding m-n null value component(s) to the first vector to extend the length of the first vector.

27. The method as claimed in claim 24, wherein transforming the second vector comprises applying an inverse of a transformation matrix to the second vector, wherein the transformation matrix preserves the Euclidean norm.

28. The method as claimed in claim 27, wherein n=7 dimension length vector, m=8 dimension length vector x=(x₁ . . . x₈), and the transformation matrix transforms the condition from E₇={(x₁ . . . x₈)εE₈|x₁+ . . . +x₈=0} in having the last component zero or transforms the condition E₇={(x₁ . . . x₈)εE₈|x₇=x₈} in having the last component zero, where E₇ is the n=7 dimension input vector lattice and the lattice E₈ is defined within Z₈ dimensional space by E₈={(x₁ . . . x₈)εZ₈|Σxᵢ≡0(mod 2)}∪{(x₁ . . . x₈)εZ₈+½|Σxᵢ≡0(mod 2)}.

29. The method as claimed in claim 28, wherein the transformation matrix is
$$( \begin{matrix}\sqrt{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{\sqrt{6}}{2} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & 1 \\ 1 & 1 & 2 \frac{\sqrt{3}}{3} + 1 & \frac{\sqrt{3}}{6} + 1 & \frac{\sqrt{3}}{6} + 1 & \frac{\sqrt{3}}{6} + 1 & \frac{\sqrt{3}}{6} + 1 & 1 \\ 1 & 1 & 1 & \frac{\sqrt{5}}{2} + 1 & \frac{\sqrt{5}}{10} + 1 & \frac{\sqrt{5}}{10} + 1 & \frac{\sqrt{5}}{10} + 1 & 1 \\ 1 & 1 & 1 & 1 & \frac{\sqrt{30}}{5} + 1 & \frac{\sqrt{30}}{30} + 1 & \frac{\sqrt{30}}{30} + 1 & 1 \\ 1 & 1 & 1 & 1 & 1 & \frac{\sqrt{42}}{36} + 1 & \frac{\sqrt{42}}{42} + 1 & 1 \\ 1 & 1 & 1 & 1 & 1 & 1 & 2 \frac{\sqrt{14}}{7} + 1 & 1 \\ 1 & 1 & 1 & 1 & 1 & 1 & 1 & 1\end{matrix} ) ,$$
the transformation matrix transforms the condition from E₇={(x₁ . . . x₈)εE₈|x₁+ . . . +x₈=0} in having the last component zero.

30. The method as claimed in claim 28, wherein the transformation matrix is
$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$
the transformation matrix transforms the condition E₇={(x₁ . . . x₈)εE₈|x₇=x₈} in having the last component zero.

31. The method as claimed in claim 27, wherein n=6 dimension length vector, m=8 dimension length vector, and the transformation matrix transforms the condition E₆={(x₁ . . . x₈)εE₈|x₆=x₇=x₈} in having the last two components zero or transforms the condition E₆={(x₁ . . . x₈)εE₈|x₁+x₈=x₂+ . . . +x₇=0} in having the last two components zero

32. The method as claimed in claim 31, wherein the transformation matrix is
$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$
where the first definition of the lattice E6 is satisfied E₆={(x₁ . . . x₈)εE₈|x₆=x₇=x₈}.

33. The method as claimed in claim 27, wherein lattice quantizing the transformed second vector comprises:
searching in D₈, wherein D₈ is defined as D₈={(x₁ . . . x₈)εZ₈|Σxᵢ≡0(mod 2)};
searching in D₈+0.5, wherein searching comprises generating a lattice vector by rounding the input vector components to an integer according the definition and where the constraint on the sum modulo 2 is not respected the rounding on the input vector component with the highest rounding error is performed in the opposite direction; and
selecting one of the lattice vectors from searched D₈ and D₈+0.5 lattices which is closest to the transformed second vector.

34. The method as claimed in claim 33, wherein reverse transforming the lattice quantized transformed second vector comprises applying the transformation matrix to the selected one of the lattice vectors from searched D₈ and D₈+0.5 lattices which is closest to the transformed second vector.

35. An apparatus comprising at least one processor and at least one memory including computer program code for one or more programs, the at least one memory and the computer program code configured to, with the at least one processor, cause the apparatus at least to:
generate a first vector of parameters defining at least one audio signal; extend the first vector of parameters to a second vector, where the first vector is length n and the second vector is length m, where m is greater than n;
transform the second vector;
lattice quantize the transformed second vector; and
reverse transform lattice quantized transformed second vector, such that the first n components of a reverse transformed lattice quantized transformed second vector are a lattice quantization of the first vector.

36. The apparatus as claimed in claim 35, wherein the apparatus caused to generate a first vector of parameters defining at least one audio signal is caused to:
divide the at least one audio signal into time frames;
transform the time frames into frequency domain components; and
divide the frequency domain components into n sub-bands such that the first vector comprises the n sub-band frequency domain components.

37. The apparatus as claimed in claim 35, wherein the apparatus caused to extend the first vector of parameters to a second vector, where the first vector is length n and the second vector is length m is caused to add m-n null value component(s) to the first vector to extend the length of the first vector.

38. The apparatus as claimed in claim 35, wherein the apparatus caused to transform the second vector is caused to apply an inverse of a transformation matrix to the second vector, wherein the transformation matrix preserves the Euclidean norm.

39. The apparatus as claimed in claim 38, wherein n=7 dimension length vector, m=8 dimension length vector x=(x₁ . . . x₈), and the transformation matrix transforms the condition from E₇={(x₁ . . . x₈)εE₈|x₁+ . . . +x₈=0} in having the last component zero or transforms the condition E₇={(x₁ . . . x₈)εE₈|x₇=x₈} in having the last component zero, where E₇ is the n=7 dimension input vector lattice and the lattice E₈ is defined within Z₈ dimensional space by E₈={(x₁ . . . x₈)εZ₈|Σxᵢ≡0(mod 2)}∪{(x₁ . . . x₈)εZ₈+½|Σxᵢ≡0(mod 2)}.

40. The apparatus as claimed in claim 39, wherein the transformation matrix is
$$( \begin{matrix}\sqrt{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & \frac{\sqrt{2}}{2} + 1 & 1 \\ 1 & \frac{\sqrt{6}}{2} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & \frac{\sqrt{6}}{6} + 1 & 1 \\ 1 & 1 & 2 \frac{\sqrt{3}}{3} + 1 & \frac{\sqrt{3}}{6} + 1 & \frac{\sqrt{3}}{6} + 1 & \frac{\sqrt{3}}{6} + 1 & \frac{\sqrt{3}}{6} + 1 & 1 \\ 1 & 1 & 1 & \frac{\sqrt{5}}{2} + 1 & \frac{\sqrt{5}}{10} + 1 & \frac{\sqrt{5}}{10} + 1 & \frac{\sqrt{5}}{10} + 1 & 1 \\ 1 & 1 & 1 & 1 & \frac{\sqrt{30}}{5} + 1 & \frac{\sqrt{30}}{30} + 1 & \frac{\sqrt{30}}{30} + 1 & 1 \\ 1 & 1 & 1 & 1 & 1 & \frac{\sqrt{42}}{36} + 1 & \frac{\sqrt{42}}{42} + 1 & 1 \\ 1 & 1 & 1 & 1 & 1 & 1 & 2 \frac{\sqrt{14}}{7} + 1 & 1 \\ 1 & 1 & 1 & 1 & 1 & 1 & 1 & 1\end{matrix} ) ,$$
the transformation matrix transforms the condition from E₇={(x₁ . . . x₈)εE₈|x₁+ . . . +x₈=0} in having the last component zero.

41. The apparatus as claimed in claim 39, wherein the transformation matrix is
$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & \sqrt{2} & 0 \\ 0 & 0 & 0 & 0 & 0 & 0 & - 1 & 1\end{matrix} ) ,$$
the transformation matrix transforms the condition E₇={(x₁ . . . x₈)εE₈|x₇=x₈} in having the last component zero.

42. The apparatus as claimed in claim 38, wherein n=6 dimension length vector, m=8 dimension length vector, and the transformation matrix transforms the condition E₆={(x₁ . . . x₈)εE₈|x₆=x₇=x₈} in having the last two components zero or transforms the condition E₆={(x₁ . . . x₈)εE₈|x₁+x₈=x₂+ . . . +x₇=0} in having the last two components zero

43. The apparatus as claimed in claim 42, wherein the transformation matrix is
$$( \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & \sqrt{3} & 0 & 0 \\ 0 & 0 & 0 & 0 & 0 & - 1 & 1 & 0 \\ 0 & 0 & 0 & 0 & 0 & - 1 & 0 & 1\end{matrix} ) ,$$
where the first definition of the lattice E6 is satisfied E₆={(x₁ . . . x₈)εE₈|x₆=x₇=x₈}.

44. The apparatus as claimed in claim 38, wherein the apparatus caused to lattice quantizing the transformed second vector is caused to:
search in D₈, wherein D₈ is defined as D₈={(x₁ . . . x₈)εZ₈|Σxᵢ≡0(mod 2)};
search in D₈+0.5, wherein searching comprises generating a lattice vector by rounding the input vector components to an integer according the definition and where the constraint on the sum modulo 2 is not respected the rounding on the input vector component with the highest rounding error is performed in the opposite direction; and
select one of the lattice vectors from searched D₈ and D₈+0.5 lattices which is closest to the transformed second vector.

45. The apparatus as claimed in claim 44, wherein the apparatus caused to reverse transform the lattice quantized transformed second vector is further caused to apply the transformation matrix to the selected one of the lattice vectors from searched D₈ and D₈+0.5 lattices which is closest to the transformed second vector.
